(19) United States
(12) Patent Application Publication
(10) Pub. No.: US 2023/0016756 A1
(43) Pub. Date: Jan. 19, 2023

(54) COATING OF CATHODE MATERIALS FOR ENERGY STORAGE DEVICES

(71) Applicant: Hunt Energy Enterprises, L.L.C., Dallas, TX (US)

(72) Inventors: Jin-Myoung Lim, Coppell, TX (US); Francisco A. Lopez, Dallas, TX (US)

(21) Appl. No.: 17/812,865

(22) Filed: Jul. 15, 2022

Related U.S. Application Data
(60) Provisional application No. 63/222,839, filed on Jul. 16, 2021.

(51) Int. Cl. H01M 4/525; H01M 4/58; H01M 10/0562; H01M 4/62

(52) U.S. Cl. CPC H01M 4/525; H01M 4/58; H01M 10/0562; H01M 4/623; H01M 4/625; H01M 2300/0068

(57) ABSTRACT

Batteries, coating materials and methods for cathode active materials, composition of cathode electrode sheets are disclosed. The battery includes a cathode selected from the group consisting of a nickel-rich material and an iron phosphate material and an ionic-electronic conducting polymeric coating on the cathode.

### CROSS-REFERENCE TO RELATED APPLICATIONS

This application claims priority to U.S. Provisional Patent Application No. 63/222,839 titled Coating of Cathode Materials for Energy Storage Devices by Jin-Myoung Lim and Francisco A. Lopez filed Jul. 16, 2021.

### TECHNICAL FIELD

This invention relates to energy storage devices and more specifically to electrical storage.

### BACKGROUND

Li-ion batteries consisting of cathode, anode, and liquid electrolytes have brought portable devices such as cell phones, tablets, and laptops into our daily lives. Ni-rich cathode materials (LiNiₓCo_{y}Mn_{z}Al_{1-x-y-z}O₂; x>=0.8) substantially increased the energy density of Li-ion batteries and enabled us to drive full electric vehicles on the road. However, Ni-rich cathodes have surfaces that are vulnerable to oxidation, decomposition, and the formation of solid-electrolyte interphase (SEI), substantially shortening their lifetimes, lowering thermal stability, and thus hindering their commercialization.

Solid-state Li batteries are a potential next generation battery for future transportation applications, such as longer-range electric vehicles, electric trucks, and electric aircrafts, which may demand higher energy than current Li-ion batteries can supply. Although the solid electrolyte separator and Li metal anode of current solid-state batteries substantially increases the energy density over Li-ion batteries, the solid-state nature leaves interfacial impedance and contact challenges between particles for Li-ion hopping and diffusion.

In Li-ion batteries, Li ions diffuse through the liquid electrolytes that can access all of the surface of the electrode particle without interfacial challenges. In contrast, in solid-state Li batteries, due to the absence of the liquid electrolytes, Li ions struggle to hop and diffuse from the electrode particles to solid electrolyte particles and films. Regardless of the ionic conductivity in bulk solid electrolyte, poor interfacial conductivity and contact challenges may hamper the utilization, commercialization, and development of solid-state Li batteries.

Aside from interfacial challenges, there is still an unraveled potential on the cathode side. Current solid-state battery cathodes require a variety of non-active materials (which do not contribute to energy and capacity) to play different roles, such as binders for mechanical structure, conducting agents for electric conductivity, and solid electrolytes for ionic conductivity. These components dilute the amount of actual cathode active material (for example, Ni-rich cathode materials), which, in turn, limits the gravimetric/volumetric energy density of the cell. Increasing the amount of the cathode active material directly increases the amount of energy a cell can store. This effect is amplified because the active material is denser than the non-active materials, meaning that volumetric energy density can be increased with higher loading as shown in FIG. 1.

### BRIEF DESCRIPTION OF THE DRAWINGS

FIG. 1 is an illustration of a relationship between volumetric energy and gravimetric energy versus mass loading of cathode active material.

FIG. 2 is a block diagram of a cathode of the current disclosure.

FIG. 3 is a stylized illustration of a cathode sheet consisting of a cathode material, conducting agent, binder, solid electrolyte, and current collector.

FIG. 4 is an stylized illustration of a cell consisting of a cathode sheet, anode sheet, and solid electrolyte film.

FIG. 5 is a stylized illustration of a cathode sheet consisting of a coated cathode material and current collector with minimized binder, solid electrolyte, and conducting agent.

FIG. 6 is a stylized illustration of a cathode sheet, anode sheet, and solid electrolyte film.

FIG. 7 is a plot of impedance data for cathodes according to the present disclosure.

FIG. 8 is a flow chart of forming a cathode according to the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### SUMMARY

This disclosure includes an ionic-electronic conducting polymeric coating to address not only poor surface stability and degradation of Ni-rich cathode materials, but also poor interfacial impedance and lower energy density with a coating which can serve multiple functions, thereby allowing decreasing of non-active materials and increasing cathode active materials loading while improving battery performances.

Example embodiments include a cathode material comprising a Ni-rich cathode material or iron phosphate cathode material and a metal oxide coating on the cathode material.

Another example embodiment includes a cathode material comprising a Ni-rich cathode material or iron phosphate cathode and a lithium metal oxide coating on the cathode material.

Another example embodiment includes a cathode material comprising a Ni-rich cathode material or iron phosphate cathode and an ionic-electronic conductive polymer coating on the cathode material.

Another example embodiment includes a cathode material comprising a Ni-rich cathode or iron phosphate cathode material and a combinatory coating of one or more of metal oxide coatings, lithium metal oxide coatings as part of ionic-electronic conductive polymer coatings on the Ni-rich or iron phosphate cathode material.

Another example embodiment includes a cathode with an ionic-electronic conductive polymer coating wherein the cathode makes up an electrode sheet, which is coated to apply the ionic-electronic conductive polymer coating.

Another example embodiment includes a cathode with an ionic-electronic conductive polymer coating wherein the cathode particles are coated as a powder to apply the ionic-electronic conductive polymer coating.

The disclosure include a battery including a cathode selected from the group consisting of a nickel-rich material and an iron phosphate material and an ionic-electronic conducting polymeric coating on the cathode.

In an embodiment the nickel-rich material includes Li₁₊ₐNiₓCo_{y}Mn_{z}Al_{1-x-y-z}O₂ (0.0<=a<=1.0, 0.5<=x<=1.0, 0.0<=y<=0.1, 0.0<=z<=0.1), less than 5 percent by weight of impurities and other elements, and less than 10 percent by weight of residual lithium compounds on the surface.

In an embodiment the lithium battery cathode material include LiFeₓMn₁₋ₓPO₄, wherein 0.0<=x<=1.0, and further wherein the lithium transition metal oxide material has less than 0.05 mol of impurities and other elements and one or more of a single crystalline primary particles and secondary particles.

In an embodiment the ionic-electronic conducting polymeric coating includes one or more of a metal oxide coating, a lithium metal oxide coating, and an ionic-electronic conductive polymer coating.

In one embodiment the batter further includes an ionically conducting liquid.

In one embodiment the metal oxide coating includes one or more of aluminum oxides, titanium oxides, cobalt oxides, nickel oxides, manganese oxides, zinc oxides, vanadium oxides, lanthanum oxides, copper oxides, silicon oxides, germanium oxides, indium oxides, selenium oxides, cerium oxides, zirconium oxides, hafnium oxides, niobium oxides, tungsten oxides, gallium oxides, lithium oxides, magnesium oxides, tin oxides, strontium oxides, barium oxides, iron oxides, sodium oxides, potassium oxides, sodium phosphates, iron phosphates, manganese phosphates, cobalt phosphates, iron silicates, manganese silicates, and cobalt silicates.

In one embodiment the lithium metal oxide coating includes one or more of lithium aluminum oxides, lithium titanium oxides, lithium cobalt oxides, lithium nickel oxides, lithium manganese oxides, lithium zinc oxides, lithium lanthanum oxides, lithium vanadium oxides, lithium copper oxides, lithium silicon oxides, lithium germanium oxides, lithium selenium oxides, lithium cerium oxides, lithium zirconium oxides, lithium indium oxides, lithium hafnium oxides, lithium niobium oxides, lithium tungsten oxides, lithium gallium oxides, lithium magnesium oxides, lithium tin oxides, lithium strontium oxides, lithium barium oxides, lithium iron oxides, lithium phosphates, lithium iron phosphates, lithium manganese phosphates, lithium cobalt phosphates, lithium iron silicates, lithium manganese silicates, and lithium cobalt silicates.

In one example embodiment the ionic-electronic conductive polymer includes one or more ionic-electronic conductive polymer materials selected from the group consisting of carbonaceous materials, metal particles, conductive ceramics, conductive polymers, lithium salts, solid electrolyte particles, binding polymers, organic solvents, metal oxides, and lithium metal oxides.

In one example embodiments the carbonaceous materials include one or more of amorphous carbon, carbon black, acetylene black, ketjen black, conductive carbon, polymer carbon residue, conductive graphite, graphite, natural graphite, artificial graphite, expandable graphite, synthetic graphite, graphite oxides, graphene oxides, graphene, a one or more layers of graphene, several layers of graphene, multi-walled carbon nanotubes, and single-walled carbon nanotubes.

In one example embodiment, the metal particles include one or more of Au, Ag, Pt, Pd, W, Ti, Sn, Cu, Al, Zn, Li, Na, K, Rb, Sc, Mg, Ca, Sr, V, Cr, Mn, Fe, Co, Ni, Si, Ge, Sn, In, Pb, As, Sb, Ru, Nb, Mo, Zr, Y, Cs, Hf, Os, and Ir.

In one example embodiment, the conductive ceramics include one or more of PbO₂, RuO₂, TiN, TiC, TiB₂, MoSi₂, n-BaTiO₃, Fe₂O₃, Ti₂O₃, ReO₃, IrO₂, and YBa₂Cu₃O₇₋ₓ.

In one example embodiment, the conductive polymers include one or more of polypyrrole, polyaniline, polycarbazoles, polyindoles, polyazepines, poly(thiophene)s, poly(acetylene)s, poly(p-phenylene vinylene), poly(p-phenylene sulfide), polystyrene sulfonate, poly(3,4-ethylenedioxythiophene).

In one example embodiment, the binding polymers include one or more of sodium dodecyl sulfonate, benalkonium chloride, cocamidopropyl betain, polyvinylpyrrolidone, polyurethane, polystyrene, polyvinylidene fluoride, cetyl alcohol, polytetrafluoroethylene, ethyl cellulose, nitrocellulose, carboxymethyl cellulose, and polyethylene oxide.

In one example embodiment, the lithium salts include one or more of LiPF₆, LiClO₄, Lithium bis(trifluoromethanesulfonyl)imide, LiPF₃(CF₂CF₃)₃, LiBF₄, LiAsF₆, lithium oxalyldifluoroborate, lithium difluoro(oxalato)borate, lithium tetracyanoborate, and lithium dicyanotriazolate.

In one example embodiment, the solid electrolyte particles include one or more of Argyrodite, Li₆PS₅X (X═Cl, Br, or ClₐBr_{b}), Li₁₀GeP₂S₁₂, Li_{3.25}Ge_{0.25}P_{0.75}S₄, Li₂S—P₂S₅, Li₇P₃S₁₁, Li₃PS₄, Li₁₀SnP₂S₁₂, lithium lanthanum zirconate, Al-doped lithium lanthanum zirconate, Ga-doped lithium lanthanum zirconate, Nb-doped lithium lanthanum zirconate, Ta-doped lithium lanthanum zirconate, W-doped lithium lanthanum zirconate, lithium aluminum titanium phosphate, lithium aluminum germanium phosphate, lithium phosphate, lithium phosphorus oxynitride, and poly(ethylene oxide)-based solid electrolytes.

In one example embodiment, the organic solvents include one or more of N-methyl-2-pyrrolidinone, ethanol, isopropyl alcohol, acetone, chloroform, methanol, acetonitrile, dimethyl carbonate, diethyl carbonate, and ethyl-methyl carbonate.

In one example embodiment, the metal oxides include one or more of aluminum oxides, titanium oxides, cobalt oxides, nickel oxides, manganese oxides, zinc oxides, vanadium oxides, copper oxides, silicon oxides, germanium oxides, selenium oxides, cerium oxides, zirconium oxides, hafnium oxides, niobium oxides, tungsten oxides, indium oxides, gallium oxides, lithium oxides, magnesium oxides, tin oxides, strontium oxides, barium oxides, iron oxides, sodium oxides, potassium oxides, sodium phosphates, iron phosphates, manganese phosphates, cobalt phosphates, iron silicates, manganese silicates, cobalt silicates, or combinations thereof.

In one example embodiment, the lithium metal oxides include one or more of lithium aluminum oxides, lithium titanium oxides, lithium cobalt oxides, lithium nickel oxides, lithium manganese oxides, lithium zinc oxides, lithium vanadium oxides, lithium copper oxides, lithium silicon oxides, lithium germanium oxides, lithium indium oxides, lithium selenium oxides, lithium cerium oxides, lithium zirconium oxides, lithium hafnium oxides, lithium niobium oxides, lithium tungsten oxides, lithium gallium oxides, lithium magnesium oxides, lithium tin oxides, lithium strontium oxides, lithium barium oxides, lithium iron oxides, lithium phosphates, lithium iron phosphates, lithium manganese phosphates, lithium cobalt phosphates, lithium iron silicates, lithium manganese silicates, and lithium cobalt silicates.

The present disclosure includes a method of forming a cathode, the method including providing a cathode powder, applying an ionic-electronic conducting polymeric coating on the cathode powder; and assembling the cathode powder into a cathode electrode.

In example embodiments, the active cathode material is a cathode powder.

In example embodiments, the active cathode material is a cathode electrode sheet.

Example embodiments further include providing a solid electrolyte separator and treating the cathode electrode and the solid electrolyte separator for improved interfacial contact and conductivity by one or more of pressing, melting, and solvation.

### DETAILED DESCRIPTION

Energy storage cathode materials of Li batteries in general such as Li-ion batteries and solid-state Li batteries intrinsically may suffer from surface degradation during operation, instability in air/moisture, reactive surface fracture, gas evolution, low/high temperature instability, and sluggish ion/electron kinetics. These challenges may cause degradation during cycling and storage at various temperatures and result in a failure to deliver fast charging and discharging. In certain example embodiments, these challenges may be addressed by extrinsic treatments such as a coating.

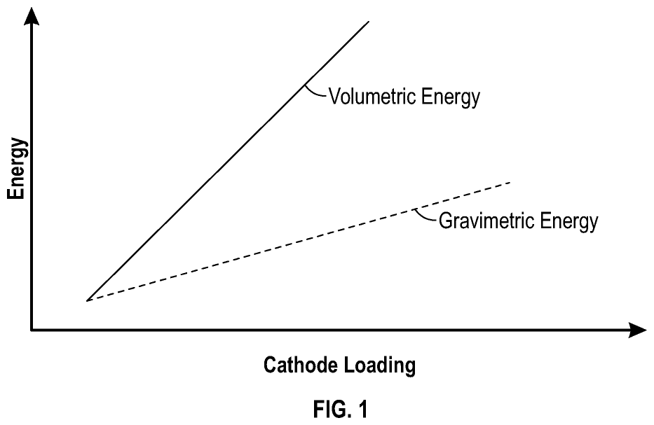

Solid-state Li batteries may be used for transportation applications such as longer-range electric vehicles, electric trucks, and electric aircrafts, which demand higher energy than current Li-ion batteries can supply. Although the solid electrolyte film separator and Li metal anode of current solid-state Li batteries substantially increase energy density over LIBs, there is still an unraveled potential on the cathode side. Current solid-state Li battery cathodes require a variety of non-active materials (which do not contribute to energy and capacity) to play different roles, such as binders for mechanical structure, conducting agents for electric conductivity, and solid electrolytes for ionic conductivity. These components dilute the amount of actual cathode active material, which in turn limits the gravimetric/volumetric energy density. Increasing the amount of cathode active material directly increases the amount of energy a cell can store. This effect is amplified because the active material is denser than the non-active materials, meaning that volumetric energy density can be dramatically increased with higher loading as shown in FIG. 1 FIG. 1 is a chart of energy versus cathode loading. In conventional Li-ion batteries as well as in solid-state Li batteries increasing the amount of cathode active materials and the minimizing the non-active materials will contribute to improved volumetric and gravimetric energy densities.

At the same time that increasing the amount of cathode active materials and decreasing the non-active materials can contribute to improved volumetric and gravimetric energy densities, without a solution to provide the same supporting roles that the non-active materials serve, the actual access to energy of the cell may actually decline as low conductivity prevents the ability for lithium ions and electronic charge to move, essentially reducing access to actual charge/discharge capacity. In addition, total or partial cell failure, a reduction in cycle life and material durability, and a change in viable operating conditions may occur which is not favorable to cell performance. Therefore, the roles of non-active materials may be emulated and enhanced by ionic and electronic conductive coating.

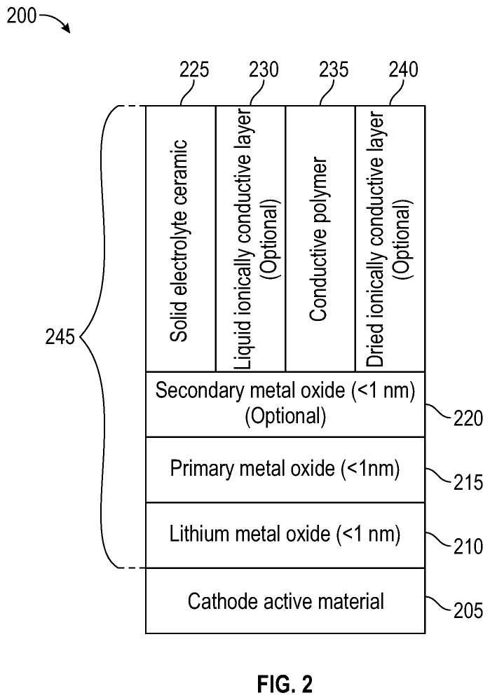

An example cathode 200 is shown in FIG. 2. The cathode 200 include a cathode active material 205. Example embodiment of the cathode active material 205. The cathode 200 further includes a lithium metal oxide layer 210 deposited on the cathode active material surface. In example embodiments, the lithium metal oxide layer 210 is less than 1 nm in thickness. The cathode 200 further includes a primary metal oxide layer 215. In some embodiments, the primary metal oxide layer 215 is less than 1 nm thick. In certain example embodiments, the cathode 200 include a secondary metal oxide layer 220, while other example embodiments may omit this layer. The secondary metal oxide layer 220 may be less than 1 nm thick. In example embodiments, the cathode 200 may include a third, fourth, fifth, sixth, seventh, eighth, ninth, tenth, eleventh, or twelfth metal oxide layers. Each of the third, fourth, fifth, sixth, seventh, eighth, ninth, tenth, eleventh, or twelfth metal oxide layers may be less than 1 nm thick. Example embodiment may include one or more additional layers on the metal oxide layers. The one or more additional layers may include a solid electrolyte ceramic 225. The additional layers may include a liquid ionically conductively layer 230. The one or more additional layers may include one or more conductive polymers 235. The one or more additional layers may include one or more dried ionically conductive layers 240. As used in this application an “ionic-electronic conducting polymeric coating” collectively refers to the lithium metal oxide layer 210, liquid metal oxide layer 215, metal oxide layers 215, 220, and any additional metal oxide layers, and additional layers (such as 225, 230, 235, and 240).

Cathode active material 205 may include Nickel-rich (Ni-rich) oxide cathode materials are one group of promising cathode materials that demonstrate more than 200 mAh/g under 4.3 V vs. Li/Li+ operation. However, Ni-rich cathodes may be vulnerable at the surface to oxidation, decomposition, and the formation of a solid-electrolyte interphase (SEI), which may shorten their lifetimes.

The active cathode materials 205 of the present disclosure may include Ni-rich cathodes. In some embodiments, the Ni-rich cathode includes less than 5 percent by weight of other elements. In certain embodiments, the Ni-rich cathode material include Li₁₊ₐNiₓCo_{y}Mn_{z}Al_{1-x-y-z} O₂ (0.0<=a<=1.0, 0.5<=x<=1.0, 0.0<=y<=0.1, 0.0<=z<=0.1), less than 5 percent by weight of impurities and other elements, and less than 10% by weight of residual lithium compounds on the surface; and one or more of a single crystalline primary particle and a combination of secondary and primary particles. The particle size of the single crystalline primary particle is less than 10 um in diameter, and the particle size of the secondary particles consisting of the primary particles is less than 100 um in diameter. In a particular embodiment, the Ni-rich cathode material include Li₁₊ₐNiₓCo_{y}Mn_{z}Al_{1-x-y-z}O₂ (0.0<=a<=1.0, 0.5<=x<=1.0, 0.0<=y<=0.1, 0.0<=z<=0.1), less than 5 percent by weight of impurities and other elements, and less than 10% by weight of residual lithium compounds on the surface; and one or more of a single crystalline primary particle and a combination of secondary and primary particles. The particle size of the single crystalline primary particle is less than 10 um in diameter, and the particle size of the secondary particles consisting of the primary particles is less than 100 um in diameter.

Example active cathode materials 205 of the present disclosure include iron phosphate cathodes. Example embodiments include, wherein the cathode material comprises a lithium iron phosphate material including LiFeₓMn₁₋ₓPO₄ (0.0<=x<=1.0) with less than 0.05 mol of impurities and other elements, and less than 5 percent by weight of residual lithium compounds on the surface; and one or more of a single crystalline primary particle configuration and a combination of secondary and primary particles. The shape of the primary single crystalline particle or secondary particles include sphere, bar, cylinder, cone, cube, cuboid, prism, and pyramid.

Example cathodes 200 may be fashioned as cathode electrode sheets, wherein the cathode material is casted or deposited in a sheet or film like manner by using one or more methods of blade coating, spin coating, slot die coating, screen coating, inkjet printing, 3D printing, 2D printing, sputtering, electrospinning, etc. For Li-ion batteries with liquid electrolytes, cathode electrode sheets may include Ni-rich cathode powder (for example, the Ni-rich cathode material describe above), a conductive carbon powder, and a polymeric binder, a conductive polymeric binder on an aluminum, stainless steel, nickel, or SUS foil, plate, or film. The conductive carbon powder of the cathode sheets may include one or more of carbon black, acetylene black, and ketjen black. The polymeric binder of the cathode sheets may include one or more of polyvinylidene fluoride, polytetrafluoroethylene, carboxymethyl cellulose, and Styrene-Butadiene Rubber along with incorporated lithium salts or ionic liquid coatings that can be dried or further processed to improve binder performance.

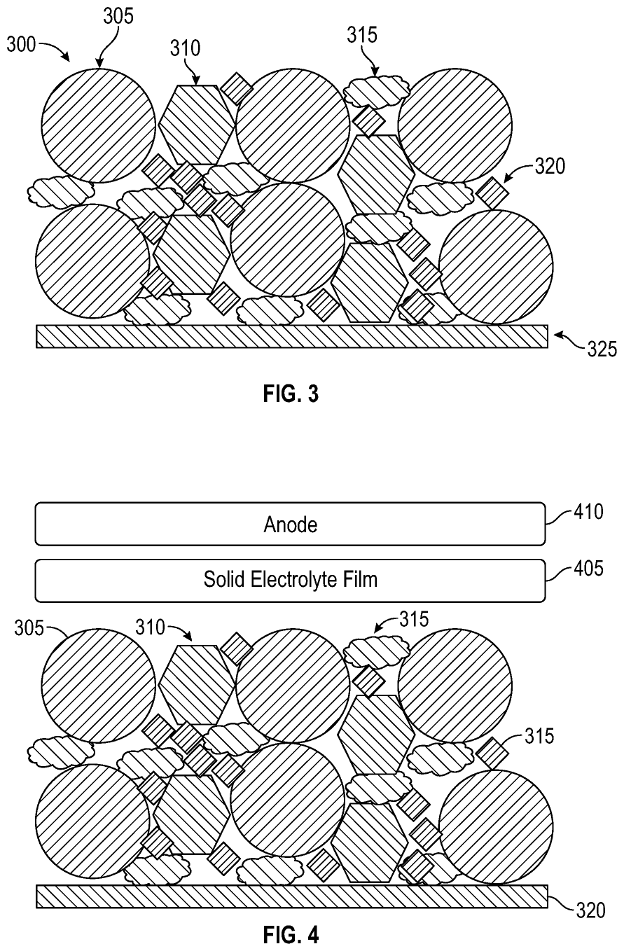

FIG. 3 is a stylized diagram of a cathode electrode sheet (shown generally at 300). In example solid-state Li batteries without liquid electrolytes, cathode electrode sheets 300 may include Ni-rich cathode powder 305 (for example, one or more of the example Ni-rich cathode materials described above), a conductive carbon powder 310, a polymeric binder 315, a conductive polymeric binder 320, and solid electrolytes on a plate or film 325 (such as an aluminum, stainless steel, nickel, or SUS foil, plate, or film). In example embodiments, one or more of these components may be modified by coating before, during, or after the cathode sheet making process.

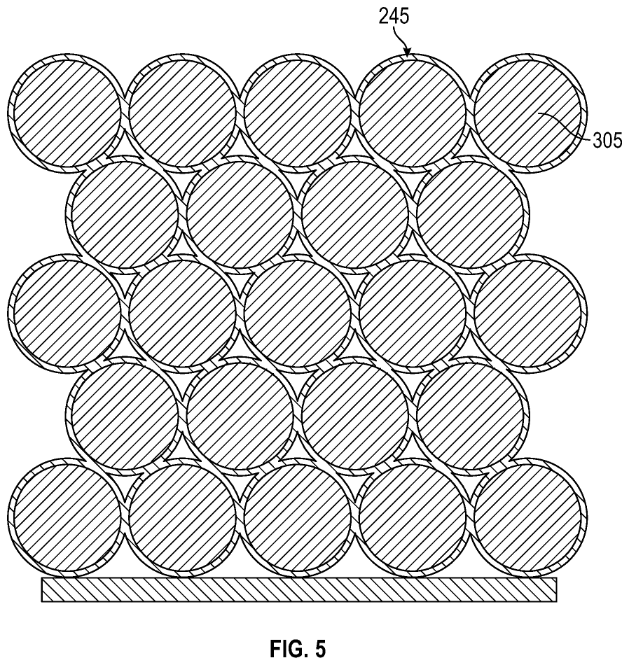

FIG. 4 is a stylized block diagram of solid-state Li battery cell. The cathode electrode sheets 300 described in FIG. 3 may be further assembled with solid electrolyte film separator 405 and an anode sheet 410 to form a solid-state Li battery cell. The conductive carbon powder of the cathode sheets may include one or more of carbon black, acetylene black, and ketjen black. The polymeric binder of the cathode sheets may include one or more of polyvinylidene fluoride, polytetrafluoroethylene, carboxymethyl cellulose, and Styrene-Butadiene Rubber. The conductive polymeric binder may include one or more of PANI, EMIM, LiTFSI, or some combination of binders, ionic liquids, and salts. The solid electrolytes of the cathode sheets may include sulfide compounds such as Argyrodite, Li₆PS₅X (X═Cl, Br, or ClₐBr_{b}), Li10GeP2S12, Li_{3.25}Ge_{0.25}P_{0.75}S₄, Li₂S—P₂S₅, Li₇P₃S₁₁, Li₃PS₄, Li₁₀SnP₂S₁₂, etc., garnet structure oxides such as lithium lanthanum zirconate, Al-doped lithium lanthanum zirconate, Ga-doped lithium lanthanum zirconate, Nb-doped lithium lanthanum zirconate, Ta-doped lithium lanthanum zirconate, W-doped lithium lanthanum zirconate, and etc., NASICON-type phosphate glass ceramics such as lithium aluminum titanium phosphate, lithium aluminum germanium phosphate, lithium phosphate, and etc., oxynitrides such as lithium phosphorus oxynitride, and polymers such as poly(ethylene oxide)-based solid electrolytes. Example solid electrolyte film separators may be fashioned as film or sheet, wherein the solid electrolyte material is casted or deposited in a sheet or film like manner by using one or more methods of blade coating, spin coating, slot die coating, screen coating, inkjet printing, 3D printing, 2D printing, sputtering, electrospinning, etc. Example solid electrolyte film separators may include one or more of solid electrolyte materials, Li-ion conducting materials, polymers, solvents, and additives. The polymers may include one or more of Styrene-Butadiene Rubber polypyrrole, polyaniline, polycarbazoles, polyindoles, polyazepines, poly(thiophene)s, poly(acetylene)s, poly(p-phenylene vinylene), poly(p-phenylene sulfide), polystyrene sulfonate, poly(3,4-ethylenedioxythiophene), sodium dodecyl sulfonate, benalkonium chloride, cocamidopropyl betain, polyvinylpyrrolidone, polyurethane, polystyrene, polyvinylidene fluoride, cetyl alcohol, polytetrafluoroethylene, ethyl cellulose, nitrocellulose, carboxymethyl cellulose, poly(ethylene oxide), or combinations thereof. Example solvents may include one or more of N-methyl-2-pyrrolidinone, ethanol, isopropyl alcohol, acetone, chloroform, methanol, acetonitrile, dimethyl carbonate, diethyl carbonate, ethyl-methyl carbonate, combinations thereof. The Li-ion conducting materials include LiPF₆, LiClO₄, Lithium bis(trifluoromethanesulfonyl)imide, LiPF₃(CF₂CF₃)₃, LiBF₄, LiAsF₆, lithium oxalyldifluoroborate, lithium difluoro(oxalato)borate, lithium tetracyanoborate, lithium dicyanotriazolate, or combinations thereof. The solid electrolyte materials include sulfide solid electrolytes such as Argyrodite, Li₆PS₅X (X═Cl, Br, or ClₐBr_{b}), Li₁₀GeP₂S₁₂, Li_{3.25}Ge_{0.25}P_{0.75}S₄, Li₂S—P₂S₅, Li₇P₃S₁₁, Li₃PS₄, Li₁₀SnP₂S₁₂, etc., solid electrolytes with garnet structure oxides such as lithium lanthanum zirconate, Al-doped lithium lanthanum zirconate, Ga-doped lithium lanthanum zirconate, Nb-doped lithium lanthanum zirconate, Ta-doped lithium lanthanum zirconate, W-doped lithium lanthanum zirconate, and etc., solid electrolytes with NASICON-type phosphate glass ceramics such as lithium aluminum titanium phosphate, lithium aluminum germanium phosphate, lithium phosphate, and etc., solid electrolytes with oxynitrides such as lithium phosphorus oxynitride, and polymer solid electrolytes such as poly(ethylene oxide)-based solid electrolytes or combinations thereof. Example additives include one or more of metal oxide nanowires such as aluminum oxide nanowires, titanium oxide nanowires, and zirconium oxide nanowires, or combinations thereof.

For solid-state Li batteries, a solid-electrolyte separator 405 may improve the functioning state of a cell. A high-performing solid-electrolyte separator 405 may further enable facile transport of Li ions from the cathode, through the interface of the cathode and separator, across the cathode, and then to the anode through the interface of the separator and anode. At the same time, the solid-electrolyte separator may promote cell durability by preventing lithium dendrite growth that could penetrate through the separator and make contact with the cathode, causing electrical shorting and cell failure. In example solid-state Li batteries, a solid-electrolyte separator may be a thin flexible film which can be assembled with, or solution coated directly on to the solid-state cathode electrode. This solid-electrolyte film solution may be prepared by mixing a combination of several components, including polymer binders, solid electrolyte materials, lithium ion conducting salts, solvents, and metal oxide conducting agents. This solution may be stirred under various mixing and heating conditions over a duration of time, after which it can be transformed into a free-standing flexible film or solution coated onto cathode material directly. In either case, solution may be coated onto a substrate by various methods including slot-die coating, blade coating, spin coating, roll-to-roll coating, and dried. The drying step can include a combination of temperature, negative pressure, and time, in which the process details have a significant effect on the final film's characteristics and performance. In the case of a free-standing solid-electrolyte film, the film can be peeled from substrate, cut, stored, treated, coated, and further processed before assembly with the cathode and/or anode of a solid-state cell. In the case of a solution-processed assembly of separator and cathode, the same techniques may be applied to the combined cathode and separator. Treatment may include aging under temperature or various gaseous conditions. Assembly can include further treatment of the separator or the cathode electrode itself, to improve performance both within the cathode and at the interface. Treatment can include an ionic-conducting coating achieved by soaking, dropping, pasting, or smearing an ionic liquid with dissolved lithium salts, which can be subsequently pressed into the cathode or cathode-separator interface and dried. The treated cathode and separator can be further processed with heating, aging, mechanical pressing, heat pressing, roll pressing, or solvent melting to improve contact between the cathode and separator at the interface. This combined cathode-separator can be assembled with the anode to make a full solid-state lithium battery cell.

In example solid-state Li batteries, an ionically conductive adhesive may be applied to one or more of cathode electrode sheets 300, anode electrode sheets 410, and solid electrolyte film separator 405. This conductive adhesive may be applied on an individual material level or at the bulk sheet level. This adhesive may decrease or minimize an interfacial contact resistance between electrode sheets and a solid electrolyte film separator. An example method of minimizing this interfacial contact resistance includes applying pressure to the battery cell to make a good contact between electrode sheets and a solid electrolyte film separator. This pressure method may, in certain instances, fail to apply a constant pressure for a longer period of battery life and requires an additional pressing equipment. Also, during the electrochemical reaction, the surface roughness of the electrode sheets and the solid electrolyte film separator may vary, resulting in losing local contact and inhomogeneous charge and discharge reactions. An ionically conductive adhesive may resolve this challenge by applying onto one or more of cathode electrode sheets, anode electrode sheets, and solid electrolyte film separator upon a battery cell assembly. The ionically conductive adhesive consists of one or more of polymers, organic solvents, and Li-ion conducting materials. Example polymers may include one or more of Styrene-Butadiene Rubber polypyrrole, polyaniline, polycarbazoles, polyindoles, polyazepines, poly(thiophene)s, poly(acetylene)s, poly(p-phenylene vinylene), poly(p-phenylene sulfide), polystyrene sulfonate, poly(3,4-ethylenedioxythiophene), sodium dodecyl sulfonate, benalkonium chloride, cocamidopropyl betain, polyvinylpyrrolidone, polyurethane, polystyrene, polyvinylidene fluoride, cetyl alcohol, polytetrafluoroethylene, ethyl cellulose, nitrocellulose, carboxymethyl cellulose, poly(ethylene oxide), or combinations thereof. The organic solvents include N-methyl-2-pyrrolidinone, ethanol, isopropyl alcohol, acetone, chloroform, methanol, acetonitrile, dimethyl carbonate, diethyl carbonate, ethyl-methyl carbonate, combinations thereof. Example Li-ion conducting materials may include one or more of LiPF₆, LiClO₄, Lithium bis(trifluoromethanesulfonyl)imide, LiPF₃(CF₂CF₃)₃, LiBF₄, LiAsF₆, lithium oxalyldifluoroborate, lithium difluoro(oxalato)borate, lithium tetracyanoborate, lithium dicyanotriazolate, sulfide solid electrolytes such as Argyrodite, Li₆PS₅X (X═Cl, Br, or ClₐBr_{b}), Li₁₀GeP₂S₁₂, Li_{3.25}Ge_{0.25}P_{0.75}S₄, Li₂S—P₂S₅, Li₇P₃S₁₁, Li₃PS₄, Li₁₀SnP₂S₁₂, etc., solid electrolytes with garnet structure oxides such as lithium lanthanum zirconate, Al-doped lithium lanthanum zirconate, Ga-doped lithium lanthanum zirconate, Nb-doped lithium lanthanum zirconate, Ta-doped lithium lanthanum zirconate, W-doped lithium lanthanum zirconate, and etc., solid electrolytes with NASICON-type phosphate glass ceramics such as lithium aluminum titanium phosphate, lithium aluminum germanium phosphate, lithium phosphate, and etc., solid electrolytes with oxynitrides such as lithium phosphorus oxynitride, wet or dried ionically conductive liquids such as imidazolium-based ionic liquids such as EMIM and BMIMBF₄, pyrrolidinium-based ionic liquids such as Pyr₁₄TFSI, Pyr₁₃TFSI, and MPPyr, pyridinium-based ionic liquids such as 1-butyl-3-methylpyridinium hydrogen sulfate, 1-butyl-3-methylpyridinium ethylsulfate, 1-butyl-3-methylpyridinium tetrafluoroborate, 1-butyl-3-methylpyridinium methylsulfate, and 1-butyl-3-methylpyridinium tetrafluoroborate and polymer solid electrolytes such as poly(ethylene oxide)-based solid electrolytes or combinations thereof. Another example type of ionically conductive adhesive consist of metal oxides including aluminum oxides, titanium oxides, cobalt oxides, nickel oxides, manganese oxides, zinc oxides, vanadium oxides, copper oxides, silicon oxides, germanium oxides, indium oxides, selenium oxides, cerium oxides, zirconium oxides, hafnium oxides, niobium oxides, tungsten oxides, gallium oxides, lithium oxides, magnesium oxides, tin oxides, strontium oxides, barium oxides, iron oxides, sodium oxides, potassium oxides, sodium phosphates, iron phosphates, manganese phosphates, cobalt phosphates, iron silicates, manganese silicates, cobalt silicates, or combinations thereof, and it can be applied by chemical vapor deposition, oxidative chemical vapor deposition, physical vapor deposition, pulsed laser deposition, electrochemical deposition, sputtering, electrospinning, thermal spray deposition, electro-spray deposition, atomic layer deposition, rotary atomic layer deposition, fluidized-bed atomic layer deposition, plasma atomic layer deposition, deposition, ball-mill atomic layer deposition, solid-state method, dry chemical method, wet chemical method, hydro solid-state method, sol-gel method, combustion method, hydrothermal method, and microwave method, or combination thereof.

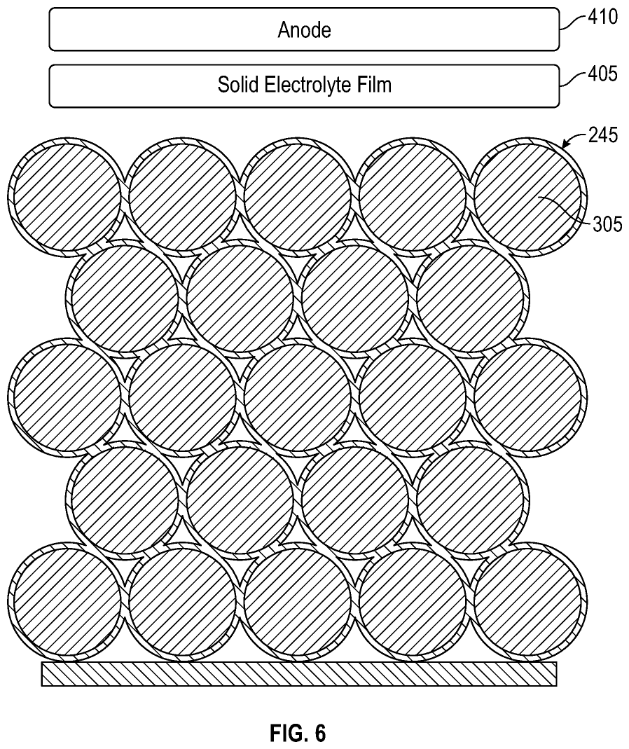

Non-active materials in cathode electrode sheets such as solid electrolytes, binder, and conducting agents may dilute the amount of actual cathode active materials, which in turn limits the gravimetric/volumetric energy density of the cell. Increasing the amount of cathode active materials in the cathode electrode sheet may directly increase the amount of energy a cell can store. In this context, example cells may include ionic-electronic conducting polymeric coatings 245 to minimize the non-active materials and maximize the amount of the cathode active material in the cathode electrode sheet as shown in FIG. 5. An example cathode electrode sheet is further assembled as a battery cell with solid electrolyte film separator 405 and anode sheet 410 as shown in FIG. 6. The assembly process for a battery cell with cathode, anode, and solid electrolyte film separator may include one or more processing conditions to improve interfacial contact between the cathode and solid electrolyte at the interface by utilizing temperature, pressure, or solvation. Example cathode electrode sheets 300 may include one or more of Ni-rich cathode powder (for example, the Ni-rich cathode material describe above), iron phosphate cathode powder (for example, the lithium iron manganese phosphate material described above), one or more coatings on the cathode powder, a conductive carbon powder, a polymeric binder, and solid electrolytes on an aluminum, stainless steel, nickel, or SUS foil, plate, or film, but the conductive carbon powder, polymeric binder, and solid electrolytes may be removed or minimally used as shown in FIG. 5. The one or more coatings on the Ni-rich cathode powder may include the ionic-electronic conducting polymeric coating that includes metal oxides, lithium metal oxides, ionic-electronic conductive polymers, or combinations thereof. The conductive carbon powder 320 of the cathode sheets may include one or more of carbon black, acetylene black, and ketjen black. The polymeric binder 315 of the cathode sheets 300 may include one or more of polyvinylidene fluoride, polytetrafluoroethylene, carboxymethyl cellulose, and Styrene-Butadiene Rubber. The conductive polymeric binder 325 may include one or more of PANI, EMIM, LiTFSI, or some combination of binders, ionic liquids, and salts. The solid electrolytes 310 of the cathode sheets may include sulfide compounds such as Argyrodite, Li₆PS₅X (X═Cl, Br, or ClₐBr_{b}), Li₁₀GeP₂S₁₂, Li_{3.25}Ge_{0.25}P_{0.75}S₄, Li₂S—P₂S₅, Li₇P₃S₁₁, Li₃PS₄, Li₁₀SnP₂S₁₂, etc., garnet structure oxides such as lithium lanthanum zirconate, Al-doped lithium lanthanum zirconate, Ga-doped lithium lanthanum zirconate, Nb-doped lithium lanthanum zirconate, Ta-doped lithium lanthanum zirconate, W-doped lithium lanthanum zirconate, and etc., NASICON-type phosphate glass ceramics such as lithium aluminum titanium phosphate, lithium aluminum germanium phosphate, lithium phosphate, and etc., oxynitrides such as lithium phosphorus oxynitride, and polymer solid electrolytes such as polyethylene oxide-based solid electrolytes.

Example metal oxides 215 and 220 of the ionic-electronic conducting polymeric coatings 245 include one or more of aluminum oxides, titanium oxides, cobalt oxides, nickel oxides, manganese oxides, zinc oxides, vanadium oxides, copper oxides, silicon oxides, germanium oxides, indium oxides, selenium oxides, cerium oxides, zirconium oxides, hafnium oxides, niobium oxides, tungsten oxides, gallium oxides, lithium oxides, magnesium oxides, tin oxides, strontium oxides, barium oxides, iron oxides, sodium oxides, potassium oxides, sodium phosphates, iron phosphates, manganese phosphates, cobalt phosphates, iron silicates, manganese silicates, cobalt silicates, or combinations thereof. The method of the metal oxide coating includes chemical vapor deposition, oxidative chemical vapor deposition, physical vapor deposition, pulsed laser deposition, electrochemical deposition, electrospinning, thermal spray deposition, electro-spray deposition, atomic layer deposition, rotary atomic layer deposition, fluidized-bed atomic layer deposition, plasma atomic layer deposition, deposition, ball-mill atomic layer deposition, solid-state method, dry chemical method, wet chemical method, hydro solid-state method, sol-gel method, combustion method, hydrothermal method, and microwave method, or combination thereof.

Lithium metal oxides of the ionic-electronic conducting polymeric coatings include lithium aluminum oxides, lithium titanium oxides, lithium cobalt oxides, lithium nickel oxides, lithium manganese oxides, lithium zinc oxides, lithium vanadium oxides, lithium copper oxides, lithium silicon oxides, lithium germanium oxides, lithium selenium oxides, lithium cerium oxides, lithium zirconium oxides, lithium indium oxides, lithium hafnium oxides, lithium niobium oxides, lithium tungsten oxides, lithium gallium oxides, lithium magnesium oxides, lithium tin oxides, lithium strontium oxides, lithium barium oxides, lithium iron oxides, lithium phosphates, lithium iron phosphates, lithium manganese phosphates, lithium cobalt phosphates, lithium iron silicates, lithium manganese silicates, lithium cobalt silicates, or combinations thereof. The method of the lithium metal oxide coating includes chemical vapor deposition, oxidative chemical vapor deposition, physical vapor deposition, pulsed laser deposition, electrochemical deposition, electrospinning, thermal spray deposition, electro-spray deposition, atomic layer deposition, rotary atomic layer deposition, fluidized-bed atomic layer deposition, plasma atomic layer deposition, deposition, ball-mill atomic layer deposition, solid-state method, dry chemical method, wet chemical method, hydro solid-state method, sol-gel method, combustion method, hydrothermal method, and microwave method, or combination thereof. Since lithium metal oxides contain lithium in the structure, they work as not only coating materials but also electrochemically active materials storing capacity and energy.

Another embodiment of a lithium metal oxide coating includes a method of using lithium from the cathode surface such as Ni-rich cathode material including Li₁₊ₐNiₓCo_{y}Mn_{z}Al_{1-x-y-z}O₂ (0.0<=a<=1.0, 0.5<=x<=1.0, 0.0<=y<=0.1, 0.0<=z<=0.1), less than 5 percent by weight of impurities and other elements, and less than 10% by weight of residual lithium compounds on the surface; and one or more of a single crystalline primary particle and a combination of secondary and primary particles. The less than 10% by weight of residual lithium compounds on the surface may be used for generating a lithium metal oxide coating without adding external lithium sources. That means a lithium metal oxide coating may be able to be achieved by the methods of metal oxides mentioned above without adding additional lithium sources. This provides effective and efficient way to use the residual lithium compounds of Ni-rich cathode materials as coating materials or electrochemically active components storing capacity and energy.

Ionic-electronic conductive polymers of the ionic-electronic conducting polymeric coatings include one or more of carbonaceous materials, metal particles, conductive ceramics, conductive polymers, lithium salts, solid electrolyte particles, binding polymers, organic solvents, metal oxides, lithium metal oxides, or combinations thereof. The carbonaceous materials include one or more of amorphous carbon, carbon black, acetylene black, ketjen black, conductive carbon, polymer carbon residue, conductive graphite, graphite, natural graphite, artificial graphite, expandable graphite, synthetic graphite, graphite oxides, graphene oxides, graphene, a few layer of graphene, several layer of graphene, multi-walled carbon nanotubes, single-walled carbon nanotubes, or combinations thereof. The metal particles include Au, Ag, Pt, Pd, W, Ti, Sn, Cu, Al, Zn, Li, La, Na, K, Rb, Sc, Mg, Ca, Sr, V, Cr, Mn, Fe, Co, Ni, Si, Ge, Sn, In, Pb, As, Sb, Ru, Nb, Mo, Zr, Y, Cs, Hf, Os, Ir, or combinations thereof. The conductive ceramics include PbO₂, RuO₂, TiN, TiC, TiB₂, MoSi₂, n-BaTiO₃, Fe₂O₃, Ti₂O₃, ReO₃, IrO₂, YBa₂Cu₃O₇₋ₓ, or combinations thereof. The conductive polymers include polypyrrole, polyaniline, polycarbazoles, polyindoles, polyazepines, poly(thiophene)s, poly(acetylene)s, poly(p-phenylene vinylene), poly(p-phenylene sulfide), polystyrene sulfonate, poly(3,4-ethylenedioxythiophene) or combinations thereof. The binding polymers include sodium dodecyl sulfonate, benalkonium chloride, cocamidopropyl betain, polyvinylpyrrolidone, polyurethane, polystyrene, polyvinylidene fluoride, cetyl alcohol, polytetrafluoroethylene, ethyl cellulose, nitrocellulose, carboxymethyl cellulose, poly(ethylene oxide), or combinations thereof. The lithium salts include LiPF₆, LiClO₄, Lithium bis(trifluoromethanesulfonyl)imide, LiPF₃(CF₂CF₃)₃, LiBF₄, LiAsF₆, lithium oxalyldifluoroborate, lithium difluoro(oxalato)borate, lithium tetracyanoborate, lithium dicyanotriazolate, or combinations thereof. Example solid electrolyte particles include one or more sulfide compounds such as Argyrodite, Li₆PS₅X (X═Cl, Br, or ClₐBr_{b}), Li₁₀GeP₂S₁₂, Li_{3.25}Ge_{0.25}P_{0.75}S₄, Li₂S—P₂S₅, Li₇P₃S₁₁, Li₃PS₄, Li₁₀SnP₂S₁₂, etc., garnet structure oxides such as lithium lanthanum zirconate, Al-doped lithium lanthanum zirconate, Ga-doped lithium lanthanum zirconate, Nb-doped lithium lanthanum zirconate, Ta-doped lithium lanthanum zirconate, W-doped lithium lanthanum zirconate, and etc., NASICON-type phosphate glass ceramics such as lithium aluminum titanium phosphate, lithium aluminum germanium phosphate, lithium phosphate, and etc., oxynitrides such as lithium phosphorus oxynitride, and polymer solid electrolytes such as poly(ethylene oxide)-based solid electrolytes. The organic solvents include N-methyl-2-pyrrolidinone, ethanol, isopropyl alcohol, acetone, chloroform, methanol, acetonitrile, dimethyl carbonate, diethyl carbonate, ethyl-methyl carbonate, combinations thereof. The metal oxides aluminum oxides, titanium oxides, cobalt oxides, nickel oxides, manganese oxides, zinc oxides, vanadium oxides, copper oxides, silicon oxides, germanium oxides, indium oxides, selenium oxides, cerium oxides, zirconium oxides, hafnium oxides, niobium oxides, tungsten oxides, gallium oxides, lithium oxides, magnesium oxides, tin oxides, strontium oxides, barium oxides, iron oxides, sodium oxides, potassium oxides, sodium phosphates, iron phosphates, manganese phosphates, cobalt phosphates, iron silicates, manganese silicates, cobalt silicates, or combinations thereof. The lithium metal oxides include one or more of lithium aluminum oxides, lithium titanium oxides, lithium cobalt oxides, lithium lanthanum oxides, lithium nickel oxides, lithium manganese oxides, lithium zinc oxides, lithium vanadium oxides, lithium copper oxides, lithium silicon oxides, lithium germanium oxides, lithium selenium oxides, lithium cerium oxides, lithium zirconium oxides, lithium indium oxides, lithium hafnium oxides, lithium niobium oxides, lithium tungsten oxides, lithium gallium oxides, lithium magnesium oxides, lithium tin oxides, lithium strontium oxides, lithium barium oxides, lithium iron oxides, lithium phosphates, lithium iron phosphates, lithium manganese phosphates, lithium cobalt phosphates, lithium iron silicates, lithium manganese silicates, lithium cobalt silicates, or combinations thereof. The method of the ionic-electronic conductive polymer coatings includes chemical vapor deposition, oxidative chemical vapor deposition, physical vapor deposition, pulsed laser deposition, electrochemical deposition, electrospinning, thermal spray deposition, electro-spray deposition, atomic layer deposition, rotary atomic layer deposition, fluidized-bed atomic layer deposition, plasma atomic layer deposition, deposition, ball-mill atomic layer deposition, solid-state method, dry chemical method, wet chemical method, hydro solid-state method, sol-gel method, combustion method, hydrothermal method, and microwave method, or combination thereof.

In fabricating a cathode electrode sheet, liquid additives may be added to the electrode sheet as an additive facilitating Li-ion diffusion. Example liquid additives comprise one or more of lithium salts and electrolyte solvents. The lithium salts include, but are not limited to, LiPF₆, LiClO₄, Lithium bis(trifluoromethanesulfonyl)imide, LiPF₃(CF₂CF₃)₃, LiBF₄, LiAsF₆, lithium oxalyldifluoroborate, lithium difluoro(oxalato)borate, lithium tetracyanoborate, lithium dicyanotriazolate, or combinations thereof. The electrolyte solvents include, but are not limited to, ethylene carbonate, propylene carbonate, dimethyl carbonate, diethyl carbonate, ethyl-methyl carbonate, 1-Ethyl-3-methylimidazolium, N,N-diethyl-N-methyl(2-methoxyethyl)ammonium, N-butyl-N-methylpyrrolidinium, N-methyl-N-propyl-imidazolium, bis(trifluoromethylsulfonyl)imide, bis(fluorosulfonyl)imide, trifluoromethanesulfonate, tetrafluoroborate, dicyanamide, chloride, or combinations thereof. These liquid additives may be converted to a solid catholyte by temperature or negative pressure which can retain Li-ion diffusion at the surface while reducing unwanted liquid effects in the solid-state system.

The materials and methods described herein may apply to generally all kinds of particles and sheets and may specifically include application in energy storage electrode materials. In particular, this may include cathodes and anodes of Li-ion batteries, solid-state Li batteries, semi-solid-state Li batteries, Li metal batteries, Li—S batteries, Li-air batteries, Na-ion batteries, Mg-ion batteries, Ca-ion batteries, K-ion batteries, Zn batteries, Zn-ion batteries, Zn-proton batteries, proton batteries, other metal-ion and metal-air batteries, and all kinds of solid electrolytes.

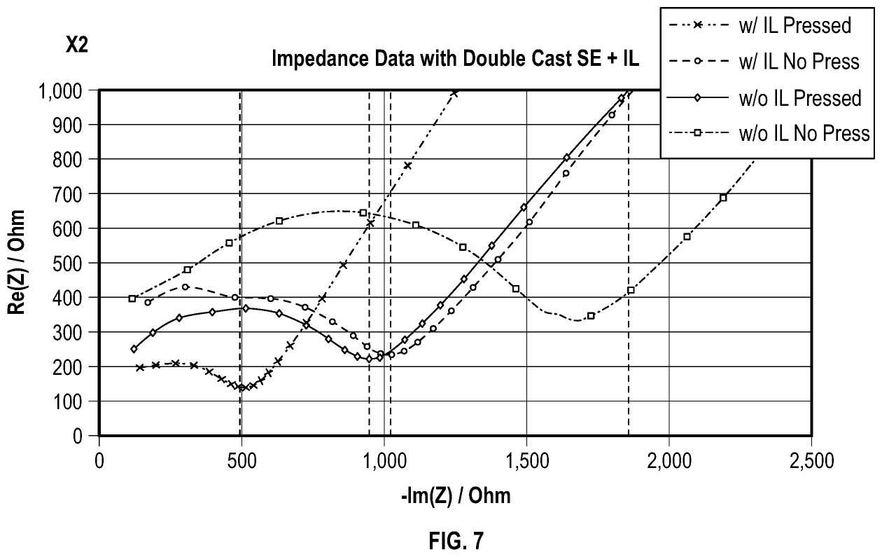

FIG. 7 is a Nyquist plot of impedance data for cathodes according to the present disclosure where the real part is plotted on the X-axis and the imaginary part is plotted on the Y-axis. The plots in FIG. 7 contain impedance data from solid-state battery cells which underwent various treatments and process engineering to reduce total cell resistance, especially at the interface of the cathode and solid-electrolyte separator. Lithium transport across the cathode-solid electrolyte separator interface and throughout the cathode and separator can be improved with treatment, reducing the impedance and overall cell resistance.

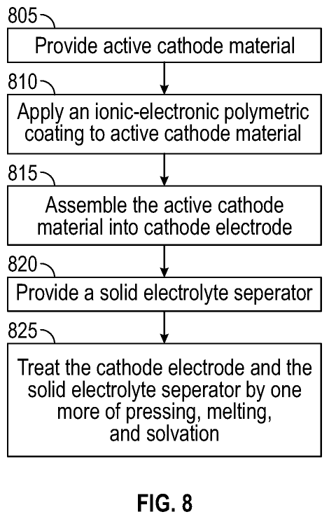

FIG. 8 is a flow chart of an example method of forming a cathode. The method includes providing an active cathode material (block 805). In some embodiments, the active cathode material is a cathode powder. In other embodiments, the active cathode material is a cathode electrode sheet. An ionic-electronic polymetric coating is applied to the active cathode material (block 810) and the active cathode material is assembled into a cathode electrode (block 815). Example embodiments include providing a solid electrolyte separator (as discussed above) (block 820). Example embodiments include treating the cathode electrode and the solid electrolyte separator by one or more of pressing, melting, or solvation in a controlled manner (block 825).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims. Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee. The indefinite articles “a” or “an,” as used in the claims, are each defined herein to mean one or more than one of the element that it introduces.

A number of examples have been described. Nevertheless, it will be understood that various modifications can be made. Accordingly, other implementations are within the scope of the following claims.

What is claimed is:

1. A battery comprising:
a cathode selected from the group consisting of a nickel-rich material and an iron phosphate material:
an ionic-electronic conducting polymeric coating on the cathode.

2. The battery of claim 1, wherein the nickel-rich material comprises:
Li₁₊ₐNiₓCo_{y}Mn_{z}Al_{1-x-y-z}O₂ (0.0<=a<=1.0, 0.5<=x<=1.0, 0.0<=y<=0.1, 0.0<=z<=0.1), less than 5 percent by weight of impurities and other elements, and less than 10 percent by weight of residual lithium compounds on the surface.

3. The coated cathode material of claim 1,
wherein the lithium battery cathode material comprises:
LiFeₓMn₁₋ₓPO₄, wherein 0.0<=x<=1.0, and further wherein the lithium transition metal oxide material has less than 0.05 mol of impurities and other elements;
and one or more of a single crystalline primary particles and secondary particles.

4. The battery of claim 1, wherein the ionic-electronic conducting polymeric coating include one or more of a metal oxide coating, a lithium metal oxide coating, and an ionic-electronic conductive polymer coating.

5. The battery of claim 4, further comprising an ionically conducting liquid.

6. The battery of claim 4, wherein the metal oxide coating includes one or more of aluminum oxides, titanium oxides, cobalt oxides, nickel oxides, manganese oxides, zinc oxides, vanadium oxides, lanthanum oxides, copper oxides, silicon oxides, germanium oxides, indium oxides, selenium oxides, cerium oxides, zirconium oxides, hafnium oxides, niobium oxides, tungsten oxides, gallium oxides, lithium oxides, magnesium oxides, tin oxides, strontium oxides, barium oxides, iron oxides, sodium oxides, potassium oxides, sodium phosphates, iron phosphates, manganese phosphates, cobalt phosphates, iron silicates, manganese silicates, and cobalt silicates.

7. The battery of claim 4 wherein the lithium metal oxide coating include one or more of lithium aluminum oxides, lithium titanium oxides, lithium cobalt oxides, lithium nickel oxides, lithium manganese oxides, lithium zinc oxides, lithium lanthanum oxides, lithium vanadium oxides, lithium copper oxides, lithium silicon oxides, lithium germanium oxides, lithium selenium oxides, lithium cerium oxides, lithium zirconium oxides, lithium indium oxides, lithium hafnium oxides, lithium niobium oxides, lithium tungsten oxides, lithium gallium oxides, lithium magnesium oxides, lithium tin oxides, lithium strontium oxides, lithium barium oxides, lithium iron oxides, lithium phosphates, lithium iron phosphates, lithium manganese phosphates, lithium cobalt phosphates, lithium iron silicates, lithium manganese silicates, and lithium cobalt silicates.

8. The battery of claim 4, wherein the ionic-electronic conductive polymer includes one or more ionic-electronic conductive polymer materials selected from the group consisting of carbonaceous materials, metal particles, conductive ceramics, conductive polymers, lithium salts, solid electrolyte particles, binding polymers, organic solvents, metal oxides, and lithium metal oxides.

9. The battery of claim 8, wherein the carbonaceous materials include one or more of amorphous carbon, carbon black, acetylene black, ketjen black, conductive carbon, polymer carbon residue, conductive graphite, graphite, natural graphite, artificial graphite, expandable graphite, synthetic graphite, graphite oxides, graphene oxides, graphene, a few layer of graphene, several layer of graphene, multi-walled carbon nanotubes, and single-walled carbon nanotubes.

10. The battery of claim 8, wherein the metal particles include one or more of Au, Ag, Pt, Pd, W, Ti, Sn, Cu, Al, Zn, Li, Na, K, Rb, Sc, Mg, Ca, Sr, V, Cr, Mn, Fe, Co, Ni, Si, Ge, Sn, In, Pb, As, Sb, Ru, Nb, Mo, Zr, Y, Cs, Hf, Os, and Ir.

11. The battery of claim 8, wherein the conductive ceramics include one or more of PbO₂, RuO₂, TiN, TiC, TiB₂, MoSi₂, n-BaTiO₃, Fe₂O₃, Ti₂O₃, ReO₃, IrO₂, and YBa₂Cu₃O₇₋ₓ.

12. The battery of claim 8, wherein the conductive polymers include one or more of polypyrrole, polyaniline, polycarbazoles, polyindoles, polyazepines, poly(thiophene)s, poly(acetylene)s, poly(p-phenylene vinylene), poly(p-phenylene sulfide), polystyrene sulfonate, poly(3,4-ethylenedioxythiophene) or combinations thereof.

13. The battery of claim 8, wherein the binding polymers include one or more of sodium dodecyl sulfonate, benalkonium chloride, cocamidopropyl betain, polyvinylpyrrolidone, polyurethane, polystyrene, polyvinylidene fluoride, cetyl alcohol, polytetrafluoroethylene, ethyl cellulose, nitrocellulose, carboxymethyl cellulose, and polyethylene oxide.

14. The battery of claim 8, wherein the lithium salts include one or more of LiPF₆, LiClO₄, Lithium bis(trifluoromethanesulfonyl)imide, LiPF₃(CF₂CF₃)₃, LiBF₄, LiAsF₆, lithium oxalyldifluoroborate, lithium difluoro(oxalato)borate, lithium tetracyanoborate, and lithium dicyanotriazolate.

15. The battery of claim 8, wherein the solid electrolyte particles include one or more of Argyrodite, Li₆PS₅X (X═Cl, Br, or ClₐBr_{b}), Li₁₀GeP₂S₁₂, Li_{3.25}Ge_{0.25}P_{0.75}S₄, Li₂S—P₂S₅, Li₇P₃S₁₁, Li₃PS₄, Li₁₀SnP₂S₁₂, lithium lanthanum zirconate, Al-doped lithium lanthanum zirconate, Ga-doped lithium lanthanum zirconate, Nb-doped lithium lanthanum zirconate, Ta-doped lithium lanthanum zirconate, W-doped lithium lanthanum zirconate, lithium aluminum titanium phosphate, lithium aluminum germanium phosphate, lithium phosphate, lithium phosphorus oxynitride, and poly(ethylene oxide)-based solid electrolytes.

16. The battery of claim 8, wherein the organic solvents include one or more of N-methyl-2-pyrrolidinone, ethanol, isopropyl alcohol, acetone, chloroform, methanol, acetonitrile, dimethyl carbonate, diethyl carbonate, and ethyl-methyl carbonate.

17. The battery of claim 8, wherein the metal oxides include one or more of aluminum oxides, titanium oxides, cobalt oxides, nickel oxides, manganese oxides, zinc oxides, vanadium oxides, copper oxides, silicon oxides, germanium oxides, selenium oxides, cerium oxides, zirconium oxides, hafnium oxides, niobium oxides, tungsten oxides, indium oxides, gallium oxides, lithium oxides, magnesium oxides, tin oxides, strontium oxides, barium oxides, iron oxides, sodium oxides, potassium oxides, sodium phosphates, iron phosphates, manganese phosphates, cobalt phosphates, iron silicates, manganese silicates, cobalt silicates, or combinations thereof.

18. The battery of claim 8, wherein the lithium metal oxides include one or more of lithium aluminum oxides, lithium titanium oxides, lithium cobalt oxides, lithium nickel oxides, lithium manganese oxides, lithium zinc oxides, lithium vanadium oxides, lithium copper oxides, lithium silicon oxides, lithium germanium oxides, lithium indium oxides, lithium selenium oxides, lithium cerium oxides, lithium zirconium oxides, lithium hafnium oxides, lithium niobium oxides, lithium tungsten oxides, lithium gallium oxides, lithium magnesium oxides, lithium tin oxides, lithium strontium oxides, lithium barium oxides, lithium iron oxides, lithium phosphates, lithium iron phosphates, lithium manganese phosphates, lithium cobalt phosphates, lithium iron silicates, lithium manganese silicates, and lithium cobalt silicates.

19. A method of forming a cathode, the method comprising:
providing a cathode powder;
applying an ionic-electronic conducting polymeric coating on the cathode powder; and
assembling the cathode powder into a cathode electrode.

20. The method of claim 19, wherein the active cathode material is a cathode powder.

21. The method of claim 19, wherein the active cathode material is a cathode electrode sheet.

22. The method of claim 19, further comprising:
providing a solid electrolyte separator; and
treating the cathode electrode and the solid electrolyte separator for improved interfacial contact and conductivity by one or more of pressing, melting, and solvation.
